(19) United States
(12) Patent Application Publication
(10) Pub. No.: US 2015/0045510 A1
(43) Pub. Date: Feb. 12, 2015

(54) EPOXY ADHESIVE, MANUFACTURE AND USE THEREOF

(71) Applicants: Christof Braendli, Zurich (CH); Andreas Lutz, Galgenen (CH); Gary L. Jialanella, Oxford, MI (US)

(72) Inventors: Christof Braendli, Zurich (CH); Andreas Lutz, Galgenen (CH); Gary L. Jialanella, Oxford, MI (US)

(21) Appl. No.: 14/381,015

(22) PCT Filed: Mar. 27, 2013
(86) PCT No.: PCT/US2013/033981

§ 371 Date: Aug. 26, 2014

Related U.S. Application Data
(60) Provisional application No. 61/619,032, filed on Apr. 2, 2012.

(51) Int. Cl. C09J 163/00

(52) U.S. Cl. CPC C09J 163/00
USPC 525/111

(57) ABSTRACT

The invention relates to epoxy adhesives. An epoxy adhesive is provided that simultaneously has low E-modulus and high glass temperature. Such adhesives are useful in the manufacture of large machinery (e.g., automobiles), and are useful for bonding different materials, such as metal and carbon fiber composite. The cured epoxy adhesive can be formulated to have an E-modulus of less than 1000 MPa, and a glass transition temperature of at least 80 C. The epoxy adhesive comprises a capped polyurethane pre polymer, a core shell rubber, and polyetheramine-epoxy adduct.

### FIELD OF THE INVENTION

The present invention relates to an epoxy adhesive composition, and to a cured epoxy adhesive having low E-modulus and high glass temperature.

### INTRODUCTION

Epoxy adhesives, including 1-component (1K) adhesives, are often used in industry, e.g., in the automotive industry, to assemble parts made of the similar material (e.g., aluminum) or unlike materials. Bonding unlike materials, for example, carbon fiber composites, glass fiber composites, CFC/steel and CFC/aluminum, or other unlike materials, can be complicated due to their different properties, such as different thermal expansion factors.

Structures or parts based on combinations of CFC with steel and/or aluminum generally go through e-coat processing. Since CFC substrates are very stiff and have different thermal expansion factors than steel and aluminum, a low E-modulus is of benefit for the adhesives. However, low modulus adhesives generally have lower mechanical performance (lap shear strength) and lower glass transition temperatures (Tg). Industrial adhesives, e.g., automotive shop adhesives, generally demand higher glass transition temperatures, not lower.

Low E-modulus adhesives have further benefits. If they are used as sealers in hemflange applications, read through issues are prevented. Further, distortion issues, especially for aluminum bonding, are reduced by low modulus adhesives.

It is known to use additives, such as plasticizers, to decrease the E-modulus of an epoxy adhesive (which could otherwise have E-moduli in the range of, e.g., 1600 to 2000 MPa). The use of plasticizers, however, also decreases Tg of the cured product. Addition of polyurethane capped prepolymers or CTBN-epoxy adducts to epoxy compositions can effectively lower the E-modulus of the cured product, but at the expense of greatly reduced Tg. The E-modulus of an epoxy adhesive decreases when the temperature increases to or above Tg. Moreover, additives that provide adhesives with acceptable E-modulus properties generally result in excessive decreases in Tg.

U.S. Pat. No. 7,919,955 (a family member of WO 2007/025007) discloses adhesive formulations comprising core shell rubber particles, an auxiliary impact modifier/toughening agent, additional epoxy resin, and a heat activated latent curing agent (hardener). The document discloses many possible auxiliary impact modifier/toughening agents, including adducts of epoxy with amine-terminated polyether, and polyurethanes that are the reaction products of a) isocyanate-terminated prepolymers and b) hydroxyl-containing epoxides and/or compounds having one or more phenolic, benzyl alcohol, aminophenyl or benzylamino groups per molecule.

U.S. Patent Publication 2009/0294057 (a family member of WO 2008/016889) discloses epoxy adhesives comprising epoxy resin, rubber particles, at least one plasticizer, and at least one curing agent. The compositions are said to form strong bonds with oil-contaminated metal surfaces while simultaneously exhibiting good impact toughness and/or impact resistance.

There remains a need for an epoxy adhesive that exhibits both low E-modulus and high glass transition temperature.

### SUMMARY OF THE INVENTION

It has been surprisingly found that compositions prepared from capped polyurethane prepolymer, core shell rubber, and polyetheramine-epoxy adduct provide epoxy adhesives with very good E-modulus and Tg properties. For examples, such adhesives have E-modulus in the range of, e.g., 300 to 1000 MPa, and/or Tg of, e.g., at least 80° C.

The present invention provides a cured epoxy adhesive having an E-modulus of 300 to 1000 MPa, and a Tg at least 80° C. The present invention also provides a mixture comprising a capped polyurethane prepolymer, 5 to 25 wt % of a core shell rubber, an epoxy resin, and a prepolymer comprising the reaction product of an epoxy with one or more of a polyether diamine or a polyether triamine.

The present invention also provides a method of manufacturing a cured epoxy adhesive having an E-modulus of 300 to 1000 MPa, and a Tg at least 80° C., the method comprising: a) obtaining a composition according to the present invention, e.g., a composition comprising a capped polyurethane prepolymer, a core shell rubber, a prepolymer comprising the reaction product of an epoxy with one or more of a polyether diamine or a polyether triamine, an epoxy resin, and a hardener; and b) exposing the composition to suitable conditions to cure the composition.

### DETAILED DESCRIPTION OF THE INVENTION

It is generally desired that the E-modulus of epoxy adhesives for automotive assembly and body shops be suitable to account for different thermal properties when materials with different thermal properties are bonded together. Under such conditions, it is preferred that an adhesive have low E-modulus. The E-modulus of epoxy adhesives according to the present invention is preferably less than or equal to 1000 MPa, more preferably less than or equal to 800 MPa, more preferably less than or equal to 600 MPa. The E-modulus is preferably at least 100 MPa, more preferably at least 300 MPa, more preferably at least 400 MPa.

It is generally desired that the Tg of epoxy adhesives for automotive assembly and body shops be higher than temperatures experienced during manufacturing and/or during operation. The glass transition temperature for automotive body shop adhesives is generally desired to be high. The Tg of epoxy adhesives according to the present invention is preferably at least 80° C., more preferably at least 90°, more preferably at least 100° C., most preferably higher than 110° C.

A cured epoxy adhesive can be improved by the inclusion of a polyetheramine-epoxy adduct, that is, a reaction product of an amine prepolymer and an epoxy resin.

The amine prepolymer may be any amine prepolymer that has at least two amine groups, preferably primary amine groups, in order to allow cross-linking to take place. Suitable amine prepolymers include polyether diamines and polyether triamines, and mixtures thereof. Polyether triamine is preferred. The polyether amines may be linear, branched, or a mixture. Branched polyether amines are preferred. Any molecular weight polyetheramine may be used, with molecular weights in the range of 200 to 6000 or above being suitable. Molecular weights may be above 1000, or more preferably above 3000. Molecular weights of 3000 or 5000 are preferred.

Suitable commercially available polyetheramines include those sold by Huntsman under the Jeffamine trade name. Suitable polyether diamines include Jeffamines in the D, ED, and DR series. These include Jeffamine D-230, D-400, D-2000, D-4000, HK-511, ED-600, ED-900, ED-2003, EDR-148, and EDR-176. Suitable polyether triamines include Jeffamines in the T series. These include Jeffamine T-403, T-3000, and T-5000. Polyether triamines are preferred, and polyether triamine of molecular weight about 5000 (e.g., Jeffamine T-5000) is most preferred. The equivalents of any of the above may also be used in partial or total replacement.

The epoxy resin that is reacted with the amine prepolymer can be any epoxy resin. Preferred epoxy resins have at least about two epoxy groups per molecule. Preferred epoxy resins include those discussed below.

Any amount of polyetheramine-epoxy adduct may be used in the present invention. The epoxy adhesive of the invention preferably has a total polyetheramine-epoxy adduct content of at least 3 wt %, more preferably at least 5 wt %, more preferably at least 10 wt %. The epoxy adhesive of the invention preferably has a total polyetheramine-epoxy adduct content up to 60 wt %, more preferably up to 40 wt %, more preferably up to 20 wt %. Some preferred amounts include 10, 15, and 20 wt %.

The core-shell rubber component is a particulate material having a rubbery core. Any core-shell rubber material may be used in the present invention. Some preferred core-shell rubber compositions are disclosed in U.S. Pat. Nos. 7,642,316 and 7,625,977.

The rubbery core preferably has a Tg of less than −25° C., more preferably less than −50° C., and even more preferably less than −70° C. The Tg of the rubbery core may be well below −100° C. The core-shell rubber also has at least one shell portion that preferably has a Tg of at least 50° C. By “core,” it is meant an internal portion of the core-shell rubber. The core may form the center of the core-shell particle, or an internal shell or domain of the core-shell rubber. A shell is a portion of the core-shell rubber that is exterior to the rubbery core. The shell portion (or portions) typically forms the outermost portion of the core-shell rubber particle. The shell material is preferably grafted onto the core or is crosslinked. The rubbery core may constitute from 50 to 95%, especially from 60 to 90%, of the weight of the core-shell rubber particle.

The core of the core-shell rubber may be a polymer or copolymer of a conjugated diene such as butadiene, or a lower alkyl acrylate such as n-butyl-, ethyl-, isobutyl- or 2-ethylhexylacrylate. The core polymer may in addition contain up to 20% by weight of other copolymerized monounsaturated monomers such as styrene, vinyl acetate, vinyl chloride, methyl methacrylate, and the like. The core polymer is optionally crosslinked. The core polymer optionally contains up to 5% of a copolymerized graft-linking monomer having two or more sites of unsaturation of unequal reactivity, such as diallyl maleate, monoallyl fumarate, allyl methacrylate, and the like, at least one of the reactive sites being non-conjugated.

The core polymer may also be a silicone rubber. These materials often have glass transition temperatures below −100° C. Core-shell rubbers having a silicone rubber core include those commercially available from Wacker Chemie, Munich, Germany, under the trade name Genioperl.

The shell polymer, which is optionally chemically grafted or crosslinked to the rubber core, is preferably polymerized from at least one lower alkyl methacrylate such as methyl methacrylate, ethyl methacrylate or t-butyl methacrylate. Homopolymers of such methacrylate monomers can be used. Further, up to 40% by weight of the shell polymer can be formed from other monovinylidene monomers such as styrene, vinyl acetate, vinyl chloride, methyl acrylate, ethyl acrylate, butyl acrylate, and the like. The molecular weight of the grafted shell polymer is generally between 20,000 and 500,000.

A preferred type of core-shell rubber has reactive groups in the shell polymer which can react with an epoxy resin or an epoxy resin hardener. Glycidyl groups are suitable. These can be provided by monomers such as glycidyl methacrylate.

A particularly preferred type of core-shell rubber is of the type described in U.S. 2007/0027233 (EP 1 632 533 A1). Core-shell rubber particles as described in the document include a crosslinked rubber core, in most cases being a crosslinked copolymer of butadiene, and a shell which is preferably a copolymer of styrene, methyl methacrylate, glycidyl methacrylate and optionally acrylonitrile. The core-shell rubber is preferably dispersed in a polymer or an epoxy resin, also as described in the document.

Preferred core-shell rubbers include those sold by Kaneka Corporation under the designation Kaneka Kane Ace, including the Kaneka Kane Ace 15 and 120 series of products, including Kaneka Kane Ace MX 153, Kaneka Kane Ace MX 156, Kaneka Kane Ace MX 257 and Kaneka Kane Ace MX 120 core-shell rubber dispersions, and mixtures thereof. The products contain the core-shell rubber particles pre-dispersed in an epoxy resin, at concentrations of approximately 33% or 25%.

Any amount of core-shell rubber adduct may be used. The epoxy adhesive of the invention preferably has a total core-shell rubber content of at least 0.75 wt %, more preferably at least 1 wt %, more preferably at least 2wt % or 5 wt %. The epoxy adhesive of the invention preferably has a total core-shell rubber content up to 20 wt % or 10 wt %, more preferably up to 6 wt %. A preferred amount includes 3 wt %.

A toughener is optionally used in the compositions and methods of the present invention. Any tougheners may be used, including, e.g., capped polyurethanes (equivalent to blocked PU) and rubber epoxy resins, as well as combinations thereof. Some preferred capped polyurethane tougheners include those described in U.S. Pat. No. 8,062,468B2, U.S. Pat. No. 5,278,257, EP2084200, EP 0308664 A1, or US 2006/0276601 A1.

In compositions and methods of the present invention, the capped polyurethane prepolymer preferably comprises at least 5 wt % of the epoxy adhesive, preferably at least 10 wt %, more preferably at least 14 wt %. The capped polyurethane prepolymer preferably comprises up to 60 wt % of the epoxy adhesive, more preferably up to 40 wt %, more preferably up to 20 wt %. One preferred amount is 16 wt %.

Epoxy resins useful in this invention include a wide variety of curable epoxy compounds and combinations thereof. Useful epoxy resins include liquids, solids, and mixtures thereof. Typically, the epoxy compounds are epoxy resins which are also referred to as polyepoxides. Polyepoxides useful herein can be monomeric (e.g., the diglycidyl ether of bisphenol A, diglycidyl ether of bisphenol F, digylcidyl ether of tetrabromobisphenol A, novolac-based epoxy resins, and tris-epoxy resins), higher molecular weight resins (e.g., the diglycidyl ether of bisphenol A advanced with bisphenol A) or polymerized unsaturated monoepoxides (e.g., glycidyl acrylates, glycidyl methacrylate, allyl glycidyl ether, etc.) to homopolymers or copolymers. Most desirably, epoxy compounds contain, on the average, at least one pendant or terminal 1,2-epoxy group (i.e., vicinal epoxy group) per molecule. Solid epoxy resins that may be used in the present invention can preferably comprise or preferably be mainly based upon Bisphenol A. For example, a preferred epoxy resin is diglycidyl ether of bisphenol A Dow Chemical DER 664 UE solid epoxy.

One preferable epoxy resin has general formula:

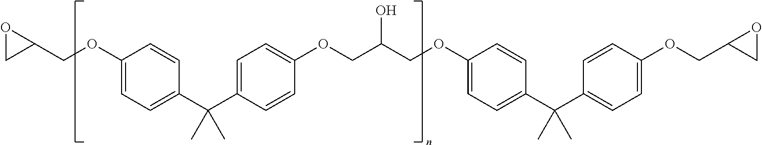

where n is generally in the range of 0 to about 25. Some basic liquid resins, e.g. D.E.R. 331, can have epoxy equivalent weights in the range of about 180 to 195 g/mol. Others, such as D.E.R. 332, can have epoxy equivalent weights in the range of about 170 to 175 g/mol.

Combinations of epoxy resins may be used to adjust properties of the epoxy adhesive.

In compositions and methods of the present invention, the epoxy adhesive may comprise any amount of epoxy resin. Preferably, the liquid and/or solid epoxy resin comprises more than 10 wt %, more preferably more than 15 wt % or 21 wt %, of the epoxy adhesive. Preferably, the liquid and/or solid epoxy resin comprises less than 50 wt %, more preferably less than 35 wt % or 30 wt %, of the epoxy adhesive. Some preferred amounts include 20 wt %, 25 wt % and 30 wt %.

Any hardener (curing agent) appropriate for a one-component (1K) or two-component (2K) epoxy adhesive may be used. As is known in the art, a 1K epoxy adhesive contains all of the ingredients for the adhesive in a single composition, and does not cure until exposed to the appropriate conditions (e.g., heat or radiation), which activates the latent hardener. In a 2K epoxy adhesive, curing can take place at ambient conditions, such that the adhesive comprises at least two different compositions, which are kept separate until use.

The hardener, preferably for a 1K adhesive composition, preferably comprises a latent hardener. Any latent hardener that does not cause hardening under ambient conditions (“ambient conditions” meaning, e.g., typical room temperature and normal lighting conditions) may be used. A latent hardener that causes the epoxy adhesive to be curable by application of heat is preferred. Some preferred hardeners include dicyandiamide, imidazoles, amines, amides, polyhydric phenols, and polyanhydrides. Dicyandiamide (also known as DICY, dicyanodiamide, and 1- or 2-cyanoguanidine) is preferred. DICY (CAS 461-58-5) has empirical formula C₂N₄H₄, molecular weight 84, and structural formula:

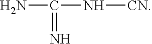

Any amount of hardener may be used as appropriate for any particular composition according to the present invention. The amount of hardener is preferably at least 1 wt %, more preferably at least 2 wt %, more preferably at least 3 wt % of the epoxy adhesive. The amount of epoxy hardener is preferably up to about 5 wt %, more preferably up to about 4 wt % of the epoxy adhesive. Some preferred amounts include 3.1, 3.3, and 3.6 wt %.

When used, fillers may be present in any useful amount, and can be determined by those of ordinary skill in the art using this document as guidance. Typically, fillers may be present in amounts more than or about 3 wt %, more preferably more than or about 5 wt % of the epoxy adhesive. Fillers may be present in amounts less than or about 20 wt %, more preferably less than or about 15 wt % of the epoxy adhesive.

Optional fillers include mineral fillers, such as calcium carbonate, calcium oxide, and talc. Calcium carbonate (e.g., sold under trade name Omya®), which can be used to reduce shrinkage and increase corrosion resistance. Calcium oxide (e.g., sold under the trade name Chaux Vive) is a humidity scavenger that may help to preserve a partially-cured epoxy adhesive prior to final curing. Talc is available, e.g., under the trade name Mistrofil®, and aluminum magnesium silicate (wollastonite) is available, e.g., under the trade name Nyad® 200.

Thixotropic agents and other viscosity regulators may also be optionally used. One such preferred example includes fumed silica (e.g., sold under the trade name Aerosil®). A preferred thixotropic agent that also improves wash-off resistance is a mixture of polyester and liquid epoxy resin (LER), such as Dynacol (25% polyester 7330 and 75% LER 330).

Castor oil wax with polyamides may also be used, and are commercially available from Rockwood under the trade name Rheotix, e.g., Rheotix 240 Other suitable gelling agents include Luvotix grades (like Luvotix HT) supplied from Lehmann, and Voss which is a polyamide without the wax or Disparlon grades supplied from Kusumoto Chemicals Ltd.

When used, fumed silica may be present in amounts more than or about 2 wt %, preferably more than or about 6 wt % of the epoxy adhesive. Fumed silica may be present in amounts less than or about 15 wt %, more preferably less than or about 12 wt % of the epoxy adhesive.

Reactive and non-reactive diluents may also optionally be used. A preferred reactive diluent is a monoglycidyl ester of neodecanoic acid, which also can act as a viscosity-reducing agent. It is commercially available, e.g., under the trade name Erisys GS-110.

One or more curing accelerators (catalysts) may be optionally used to, e.g., modify the conditions under which a latent catalyst becomes catalytically active. For example, when a high-temperature latent hardener such as DICY is used, e.g., in a heat-curable epoxy adhesive, a curing accelerator can be optionally used to reduce the temperature at which DICY becomes catalytically active. Inclusion of a curing accelerator may convert a 1K adhesive to a 2K adhesive. A preferred curing accelerator for a heat-curable epoxy adhesive includes a tertiary polyamine embedded in a polymer matrix. A preferred example is 2,4,6-tris(dimethylaminomethyl)phenol integrated into a poly(p-vinylphenol) matrix, or Rezicure matrix such as described in U.S. Pat. No. 4,659,779 (and its family members U.S. Pat. Nos. 4,713,432 and 4,734,332; and EP-A-0 197 892).

When used, curing accelerator may be present in any amount that suitably adjusts the activation condition of latent catalyst. Preferably, a curing accelerator may be present in amounts more than or about 0.2 wt %, more preferably more than or about 0.5 wt % of the epoxy adhesive. Preferably, curing accelerator may be present in amounts less than or about 5 wt %, more preferably less than or about 2 wt % of the epoxy adhesive.

At least one adhesion promoter may also be optionally used. Preferred adhesion promotes include epoxy silanes, e.g., sold under the trade name Silquest™ A-187.

At least one surfactant or wetting agent may be optionally used. A preferred wetting agent is a non-ionic fluorinated polymer. Such agents are also preferably capable of absorbing residual oils (e.g., manufacturing and processing oils) on metal surfaces, thereby facilitating adhesion to metal surfaces.

At least one aliphatic phenol may also be optionally used, preferably a phenol derivative with an aliphatic group in the meta-position, e.g., cardanol. Such compounds promote adhesion and corrosion resistance. Cardanol is commercially available, e.g., under the trade name Cardolite™ NC 700.

Other additives may also be used. Some non-limiting examples of other additives include flexbilized epoxy resins such as fatty acid epoxy adducts, gelling compounds such as polyester or PVB, and flame retardants such as aluminium-tris-hydroxide. Pigments or coloring agents, e.g., Irgalite® green, may also be used.

Plasticizers are preferably not employed in compositions of the present invention as they tend to decrease Tg. Plasticizers include sulfonates, phosphate esters, sulfonamides, glycerin triesters, dialkyl esters of aliphatic dicarboxylic acids, glycol esters of benzoic acid, and mixtures of one or more thereof. If used, plasticizers are preferably kept to less than 0.1 wt %.

The present invention provides epoxy adhesives that may be used on a variety of surfaces. Some suitable materials include metals (e.g., aluminum, steel), thermoplastic polymers (e.g., polyethylenes, polypropylenes, polyurethanes, acrylics, and polycarbonates, including copolymers, terpolymers, etc.), thermoset polymers (e.g., vulcanized rubber, urea-formaldehyde foams, melamine resins), wood, carbon fiber composites (CFC), glass fiber composites (GFC), and other composites. The epoxy adhesives may be used to bond identical materials (e.g., steel and steel), similar materials (e.g., steel and aluminum) or dissimilar materials (e.g., CFC/steel; CFC/aluminum; polycarbonate/vulcanized rubber; or aluminum/wood). Other combinations of these and other materials are also suitable.

Epoxy adhesives according to the present invention are suitable for use in industrial e-coating processes, e.g., in the automotive assembly industry. Complete knock down (CKD) methods of assembly are included in the present invention. The present invention includes the epoxy adhesive in the uncured state (whether, e.g., 1K or 2K), and in the cured state. The present invention includes products bonded with epoxy adhesives according to the present invention, e.g., products bonded with a cured epoxy adhesive having an E-modulus of 300 to 1000 MPa, and a Tg at least 80° C.

Methods according to the present invention include preparation of an epoxy adhesive by combining a capped polyurethane prepolymer, a core shell rubber, an epoxy resin, a hardener, and a polyetheramine-epoxy adduct. Other components may also be combined with the epoxy adhesive. Methods according to the present invention also include obtaining (e.g., manufacturing; purchasing; mixing components of a 2K epoxy; etc.) an epoxy adhesive according to the present invention and exposing the epoxy adhesive to conditions to partially or completely cure the epoxy adhesive composition.

The present invention also provides a manufacturing method that comprises bonding two components with an epoxy adhesive according to the present invention, followed by partially or completely curing the epoxy adhesive.

### EXAMPLES

Some embodiments of the invention will now be described in the following Examples, wherein all parts and percentages are by weight unless otherwise specified.

Example compositions were cured for 30 minutes at 180° C.

E-modulus, tensile strength, and elongation at break may be determined using a dumbbell specimen, type no. 5A, according to DIN EN ISO 527-1/-2.

Glass transition temperature may be measured by DSC analysis to determine the peak onset and the peak maximum as well as the glass transition temperature. Measurements are done from 25 to 250° C. and a heating rate of 15° C. per minute. DMA measurements are done on a TA Instruments AR2000 using 1 Hz frequency, a heating rate of 2° C./min and a range from −40 to 150° C.

Lap shear strength may be determined according to DIN EN 1465; at 23° C., at 10 mm/min, using 1 mm thick substrates (HC420LAD+Z100MB/AA6016 Ti/Zr); bonding dimension: 45×10 mm; and adhesive layer thickness 0.3 mm.

Impact peel may be determined according to ISO 11343 (test speed 2 m/s); 1 mm thick substrates (HC420LAD+Z100MB); bonding dimension: 30×20 mm; and adhesive layer thickness: 0.3 mm.

Four samples are prepared, one comparative example, and three examples within the invention. The compositions are as shown in Table 1. Results of mechanical performance are shown in Table 2.

TABLE 1

| | Comparative | | | |
|---|---|---|---|---|
| [in wt %] | Example | Example 1 | Example 2 | Example 3 |
| Toughener A | 34 | 16 | 16 | 16 |
| Epoxy resin | 24.6 | 24.65 | 29.65 | 19.95 |
| CTBN epoxy adduct (e.g. | 5 | | | |
| Struktol 3604 from | | | | |
| Schill & Seilacher) | | | | |
| Core Shell Rubber epoxy | | 10 | 10 | 10 |
| adduct (e.g. MX153 | | | | |
| from Kaneka) | | | | |
| Jeffamine-Epoxy adduct | | 15 | 10 | 20 |
| Rheology modifier [e.g. | 5 | 3 | 3 | 3 |
| Rheotix 240 from | | | | |
| Rockwood)] | | | | |
| Filler | 27.5 | 27 | 27 | 27 |
| Dicyandiamide | 3.1 | 3.4 | 3.6 | 3.1 |
| Catalyst | 0.8 | 0.95 | 0.95 | 0.95 |
| Sum in wt % | 100 | 100 | 100 | 100 |

TABLE 2

| | Compara- | | | |
|---|---|---|---|---|
| | tive | Example | Example | Example |
| | Example | 1 | 2 | 3 |
| E-Modulus | 430 MPa | 500 MPa | 800 MPa | 350 MPa |
| Glass transition | 60° C. | 115° C. | 113° C. | 115° C. |
| temperature (DSC) | | | | |
| Glass transition | 59° C. | 112° C. | 111° C. | 113° C. |
| temperature (DMA) | | | | |
| Lap Shear | 16.9 MPa | 18.9 MPa | 20.6 MPa | 17.3 MPa |
| (HC420LAD + Z100MB/ | | | | |
| AA6016 Ti/Zr + E1) | | | | |
| Impact peel [J], | 8 | 19.1 | 18.3 | 18.0 |
| RT (HC420LAD + | | | | |
| Z100MB) | | | | |
| Impact peel [J], −40° C. | 6 | 12.9 | 12.2 | 14.6 |
| (HC420LAD + Z100MB) | | | | |

Toughener A is a secondary-amine blocked PUR (e.g., as in US 2006/0276601, preparation of a diisopropylamine capped toughener according to formula I): 79.29 wt % dried PolyTHF 2000 (BASF), 0.54 wt % dried TMP (Merck), 13.29 wt % HDI (Bayer/Merck) are mixed at 85° C. to homogeneity. Then 0.08 wt % Snapcure 3030 (Johnson Matthey) is added and the mixture is allowed to react at 85° C. for 1 hour under nitrogen atmospheres.

To the product, 6.8 wt % diisopropylylamine (Merck) is added and the mixture is stirred for additional 60 min under nitrogen atmosphere. Degas the reaction product for 20 min under vacuum. Reaction proceeds until the NCO content is 0.0% (by FTIR).

The epoxy resin is a liquid/solid epoxy resin (17.53% D.E.R. 330, 46.28% D.E.R. 331 and 36.2% D.E.R. 671), as may be obtained from TDCC.

The core shell rubber is the product MX 153, which can be obtained from Kaneka.

The Jeffamine-epoxy adducts in the Examples can be obtained by reacting e.g. 45.2 wt % Jeffamine D-2000 (available from Huntsman) at 100° C. for 60 minutes with an epoxy resin 54.8 wt % D.E.R. 332 (available from TDCC).

The rheology modifier is Rheotix 240 (hydrogenated castor oil derivative supplied by Rockwood) or Dynacoll 7381 (polyester supplied by Evonik).

The filler is a combination of five ingredients: 8 wt % CaCO₃, 2wt % wollastonite (Nyad 200), 6.5 wt % CaO, 3 wt % Chlorit (Mistrofil), and 7 wt % SiO₂.

The dicyandiamide is Amicure CG 1200 (Air Products).

The catalyst is a latent amine catalyst comprising 2,4,6-tris(dimethylaminomethyl) phenol integrated into a Rezicure matrix. (WO2012006001A2)

1. A cured epoxy adhesive having an E-modulus of 100 to 1000 MPa, and a Tg at least 80° C.

2. The cured epoxy adhesive of claim 1, which is obtained by curing a composition comprising a capped polyurethane prepolymer, a core shell rubber, an epoxy resin, a hardener, and a polyetheramine-epoxy adduct.

3. The cured epoxy adhesive of claim 2 wherein the composition comprises 5 to 25 wt % of the capped polyurethane prepolymer.

4. The cured epoxy adhesive of claim 2 wherein the composition comprises 0.75 to 20 wt % of the core shell rubber.

5. The cured epoxy adhesive of claim 2 wherein the polyetheramine-epoxy adduct comprises a reaction product of an epoxy with one or more of a polyether diamine or a polyether triamine.

6. The cured epoxy adhesive of claim 2 wherein the polyetheramine-epoxy adduct comprises the reaction product of an epoxy with a polyether triamine.

7. The cured epoxy adhesive of claim 2 wherein the composition comprises 5 to 40 wt % of the polyetheramine-epoxy adduct.

8. The cured epoxy adhesive of claim 2 having a Tg at least 100° C.

9. A method of manufacturing a cured epoxy adhesive having an E-modulus of 300 to 1000 MPa, and a Tg at least 80° C., the method comprising:
a) obtaining a composition comprising a capped polyurethane prepolymer, a core shell rubber, a prepolymer comprising the reaction product of an epoxy with one or more of a polyether diamine or a polyether triamine, an epoxy resin, and a hardener; and
b) exposing the composition to suitable conditions to cure the composition.

10. A mixture comprising a capped polyurethane prepolymer, 5 to 15 wt % of a core shell rubber, an epoxy resin, and a prepolymer comprising the reaction product of an epoxy with one or more of a polyether diamine or a polyether triamine.
